(19) United States
(12) Patent Application Publication
(10) Pub. No.: US 2005/0208803 A1
(43) Pub. Date: Sep. 22, 2005

(54) Method for real time synchronization of a computing device user-definable profile to an external storage device

(75) Inventors: Santu Rohatgi, Lutz, FL (US); Peter W. Rung, Lutz, FL (US); Ryan R. Rohatgi, Lutz, FL (US)

Correspondence Address: LARSON AND LARSON, 11199 69TH STREET NORTH, LARGO, FL, 33773, US

(73) Assignee: CEELOX, INC.

(21) Appl. No.: 11/070,536

(22) Filed: Mar. 2, 2005

Related U.S. Application Data
(60) Provisional application No. 60/554,853, filed on Mar. 19, 2004.

(51) Int. Cl. H01R 13/62

(52) U.S. Cl. 439/159

(57) ABSTRACT

A method and apparatus for real time synchronization of a computing device profile using an external storage includes a method for copying a user profile from a first computer system to an external storage device, attaching the external storage device to a second computer system and restoring the user profile from the storage device onto the second computer system. For added security, the user profile may be encrypted upon the external storage device.

### PRIOR APPLICATIONS

This U.S. nonprovisional application claims priority to U.S. provisional application S. N. 60/554,853, filed on Mar. 19, 2004.

### BACKGROUND OF THE INVENTION

1. Field of the Invention

This invention relates to a method for synchronizing a computing device profile to an external storage device, while encrypting the information on-the-fly. More particularly, it relates to a method for synchronizing, in real time, a computing device profile to an external storage device interfacing with the device, the computing device profile definable by the device user or operator.

2. Description of the Prior Art

Technological advances continue to provide many new devices used to receive, compile, organize, analyze, and store information, all of which can be considered as the processing of information (also known as the processing of data). The type of information needed may well dictate that a specific type of device be employed. However, what is more determinative than device type is that the processing of information will occur. And if processing will occur, a computing device is typically best suited. Computing devices work well in verifying that information received is accurate, seeing that accurate received information is properly separated, organizing this properly separated information in a form for analyzing and making a decision, based upon well-defined logic. This decision can then be used to answer a question or calculate a probability for a person seeking such answer or calculation, or can be used to provide instructions to other devices of all types. As used herein, the definition for a computing device is any device capable of receiving, processing and presenting data. And, information, as used above and throughout this document is interchangeable with data and carries the same meaning.

There are not many areas of modern technology that have seen the number of significant advances than in the art of computing devices. To be more specific, significant advances have been made in electronically driven computer devices and computer devices capable of communicating with one another or working together along a network. Some examples of major advancements in electronic computing devices include Automatic Teller Machines (ATMs), home computers, computer workstations, computer network servers, MP3 music player/recorders, cellular telephones, Personal Digital Assistants (PDAs), palmtop computers and even wristwatches. Most of these computing devices have become so useful in both the business world and in the personal lives of people that they are now considered an integral part of life as a whole. Electronic computing devices can make even the most complicated and time consuming tasks much simpler to perform and quicker to complete by stripping away tedious aspects and responsibilities of the task. As such, advancing technology in electronic computing devices now makes it possible for people to perform tasks that were not even imaginable 15-20 years ago, such as, the sending of a text message or a document to another part of the world in just a few seconds. Because of these significant advancements, people are finding that they are using almost identical computing devices for business and personal reasons. Nowhere is this truer than in a category of electronic computing devices including, but not limited to, home computers, office workstations, laptop computers, palmtop computers, PDAs, tablet PCs, and all other like computing devices. And, for the purposes of this patent application, this category, as listed directly above will be defined as personal computers.

Looking at this defined category of personal computers, an aspect of commonality that exists among all of them can be found. This commonality is that each device has a profile. As used herein, profile is everything existing within a computing device that defines its persona and capabilities, which are within the constraints of its memory system and, which make the device operate. A device profile can therefore include, but is not limited to, data files (mp3, MPEG, word processor files, jpg, etc. . . .), applications, operating system, and all of the user-defined preferences and settings available to the device user. These user-defined preferences and settings include, but are not limited to, desktop environment, bookmarks on browser, cookies, specific application settings, e-mail files, non-licensed programs and applications, folder structure of files, and an address book. It is important to note that the definition of profile, used herein, does not attempt to exclude other electronic computing devices that are not defined within the category. Accordingly, any electronic computing device may be capable of having a profile. However, personal computers are chosen for illustrating and further defining the word profile and its significance as it applies to a category of electronic computing devices.

As a personal computer is used over time, its profile will grow and mature from a point of creation (a point in time, which the person who is to operate the computer, now has control). When talking about a PDA or a home computer, laptop computer or palmtop computer, the point of creation is most likely the date and time of purchase. When talking about an office workstation on a LAN or an Intranet (two common computer network architectures used in business), the point of creation is most likely the workstation operator's first day on the job or the day he is given a workspace and some level of control over the workstation assigned to, and located in, his workspace.

As a profile begins to grow from a point of creation, it instantly begins to form a unique persona different than any other like workstation. So, for example, if two personal computers (two workstations) are created at the same time (having the same creation point), each having exact capabilities, equal user access and control over preferences and settings, and identical applications and operating system, each profile will begin establishing a unique user profile diverging from one another as they grow and mature until each profile is completely different. A measurable definable characteristic of each profile can be used to prove they are different and that one is not like the other, even though they have the same time of creation (birth). This holds true even if the two computers are operating side by side and being used within the company for the same purpose (i.e. two employees have identical responsibilities and are performing same tasks). Divergence grows even further away as time continues to pass, because every single task and every keystroke ever carried out on either computer can effectively modify the device profile and therefore its persona.

An analogy between the profile of a personal computer, or other electronic computing device, can be made to that of a personality of a human being. For instance, both can grow and mature and become more complex over time. Both can be defined as having unique characteristics, which define the person or profile of the device (both have measurable identities). An argument can therefore be made that over time and through use, a personal computer, or other electronic computing device, begins to develop a personality that is unique and personal to the user of that particular device, which is defined as the device profile.

In many cases, and something that is considered a problem in the prior art, is that an operator performs his required duties at work on his assigned workstation, at his place of employment, and then travels home to operate his home computer, personally owned under his control, and located within his house. This leads to the formation of two distinct profiles on two separate computers, which over time, begin to drift further and further apart. In most cases, these two profiles, which are unique to one user, but loaded on two separated computers, never meet and are typically prohibited from meeting, based upon restrictions in removing the business computer from the job site. If the operator adds a laptop computer to the equation, he now has three profiles. Better yet, he then purchases a PDA, capable of interfacing with the laptop and home computer on some minimum threshold level of connectivity for permitting simple transfers of scheduling data and so that addresses can be downloaded to either the home personal computer or laptop computer. This type of inefficient connectivity falls horribly short of being able to fully interface all four devices as one large profile, thereby taking advantage of all abilities of all computing devices in one respect or another. The operator now has four distinct profiles on four separate computing devices, wherein only three, at best, can be networked in some loosely established home network. And any network connectivity would most likely require a hub or router, merely adding complexity to a problem that was already complex enough. Even in the event of network connectivity between the operator's three home computers, transfer of data files and some other simple files, such as bookmarks, is about all that can be shared among the three. Much of this can be solved quite easily, efficiently and at a very low cost. The solution to this problem and how a person can implement a single profile on all four computing devices is the subject of one embodiment of the present invention and will be discussed below hereinafter.

Very few people have the luxury of using one electronic computing device for both their personal and business lives. If such a luxury exists, then a unified profile can be created by melding certain aspects of the operator's personal identity with his business personality. This would most likely require a portable electronic computing device, such as a laptop, but having extensive storage capacity. The practice of implementing a unified profile on a single device has other disadvantages that include the inadvertent revealing of privacy related aspects of the personal identity to business associates and colleagues, or violating document security protocols of the employer by mistakenly removing intellectual property or confidential or trade secret protected documents and files from the confines (digitized central storage area) of the company employer for which the employee works. Ensuring that privacy remains intact and secrecy is not violated, requires that the single device unified profile not be fully explored for either the business or personal sides effectively, limiting the abilities to develop each profile to its fullest extent utilizing encryption. As a final note to a unified profile on a single device, loss or destruction of the device or catastrophic failure of a device component (i.e., hard drive failure) results in an immediate and complete loss of all work and personal related data, all applications and all preferences and settings for the unified profile, which are all potentially unrecoverable.

In view of the above, and the risks associated with total loss of data, it appears too detrimental to attempt a unified profile on a single computing device. Accordingly, the only other viable option appears to be through the use of two computing devices (such as, first and second computers). In this scenario, an operator would attempt to update her second computer each and every time her first computer changed or a file was updated, or vice versa, to remain in real time synchronization. However, this result is absurd.

First, the time expended in attempting this protocol would leave the operator with no other time to do anything else. Given the extremely fast speeds of modern computer processors, it would be impossible for anyone to keep up with the processing of any computer in this manner. Secondly, to say the above method of updating could be affected in real time is misleading. Any human implemented method of this type would merely stump any possible result that could be realized since it cannot be carried out in real time. Real time, as defined herein and which is generally accepted, pertains to a data-processing system that controls an ongoing process and delivers its output (or control inputs) no later than at the time when these are needed for effective control. Based on this definition, it seems impossible that anyone could effectively determine that a file had been added or changed, or a computer established a connection between the two computers, and make the file copy or addition, all within the time necessary, but no later than when needed to affect some result or control. Even further, how could anyone actually know if a change had occurred necessitating this type of action? People simply do not possess the intuitive knowledge to know exactly which files may or may not have been updated and/or added during the operation of the first computer, regardless of whether it is a simple or very complex function, all within real time. Nor, are there any mechanisms, devices or methods in the prior art which have this same intuitive knowledge, through programming, that act within real time so that an absolute determination from an overall analysis throughout the entire computer includes every application setting file embedded deep within the file structure hierarchy for all applications, as well as each attribute of the desktop environment including, but not limited to, wallpaper settings, screen saver, power control and clock settings. For each user-defined profile there can be unlimited files to track.

There is an inference of synchronization in the prior art method above that at some point in time, but certainly not in real time, they are two devices having common elements. And since synchronization is defined as the ability to make at least two data elements common or same, the method above could be synchronized for a period of time. However, real time plays havoc on this human implemented method, since as soon as synchronization is achieved within the system, changes and additions to files must again be located and synchronized to the other computer, because real time requires so. In fact, by the time a person realized that a file had changed, before he/she could do anything about it, something else will change.

It can therefore be said, that nothing in the prior art permits the synchronization, in real time, encrypting information on-the-fly, of a user-defined profile, of a first computing device to a second computing device utilizing an external storage device such that the two computing devices look and operate as identical devices at any given point in time. It should be noted that some one-time event executing programs do exist but fall way short of real time synchronization due to an inability to continue operating after the single event has executed. There are also single program synchronization programs that permit coupling between two computing devices but for just one program, and they do not allow for copying over base files from one computer to another. Single program synchronization programs are more analogous to a pseudo, temporary sync of minor-proportions. It is therefore clear, that without the novel method of the subject invention of this patent application, real time synchronization of at least two computing device user-defined profiles, employing an external storage device, is not possible.

A similar problem in linking two computers presents itself when thinking in terms of upgrading system hardware and software. First, you must ask, what am I updating? Am I updating my six year-old computer to a new computer with both new hardware and software? Or, am I just updating software (i.e., the latest and greatest operating system)? Or am I just updating older hardware and I want to keep my latest operating system? Knowing your intentions, as well as your expectations, will certainly govern your actions as they apply to the update. Misconception of what files and settings will be on a new computer when it is brought to life has been a problem for years in the computer repair industry. Almost all repair facilities simply do not take responsibility for backing up old files and carrying them over to the new computer. Further, repair facilities lack ability to bring forth the user-preference and application settings embedded within the old computer. Sometimes a computer owner simply feels they have no choice but to upgrade, and makes a hasty decision due to false understandings and current events. Y2K caused so many people to update so quickly, out of concern for potential catastrophic failure they did not take the time to back-up certain files, which resulted in a total loss of those files. In the prior art, there is simply no way to exchange (upgrade) your computer for a new one without losing a significant portion, if not all, of the computer user-defined preferences and settings.

Anyone who relies on, or at least utilizes, a computer for any part of their business or personal life becomes quite dependent on them and finds it difficult to function without one when away from their typical environment and home. In fact, the desire to constantly check e-mail, inquire into news reports, chat with online-friends and family, or even log into a company network to check schedules and work assignments has driven a whole business related to providing access to the Internet for satisfying people's desires or assisting them in accomplishing their professional and personal goals. In public, portals to the Internet are found in airports, cafes, bars, coffee shops, hotels and public libraries. However, if you want access to your personal environment (profile) and you are away from your personal computer, laptop or palmtop, what can you do? Affectively nothing. In the prior art, when you are away from your computer and its unique profile, you lose access to features that provide convenience and make your time on the computer more enjoyable and more productive. Currently, there is no way to remotely bring forth your profile to enjoy the features you have defined in your profile. Further, when you operate a “leased” machine you tend to leave a trace of your presence behind which is discoverable. There is nothing in the prior art to erase these traces, and this can cause problems.

If a traveling executive or a member of the military, both having high levels of security access to their respective professions, must review confidential documents before making an impartial decision, but is in a visible public forum, there is no device, mechanism, or method that permits this executive or member of the military to go and look at the required documents without leaving a trace. Even if they log-in and do not review any material, their presence on the sign-in-site can leave a trace signature or footprint behind that is discoverable through research and due diligence.

In another example, a person may wish to take a multitude of files from one location to another, but does not provide access to all the files. For instance, she may want to show someone a plethora of confidential documents relating to her business, yet, she does not want to show each and every document. However, she wants to bring them in an organized fashion, such as a slide slow presentation she created, but does not want to risk the chance that the viewing party may see the other restricted files. Currently, there is no mechanism, device or method that permits instant copying of all documents from one computing device to another for taking to a remote location, which permits restriction of selected files or folders based upon the user-defined profile which interfaces a privacy function for erasing any trace at the remote location to which she has traveled. Improvements are clearly needed to permit such methods, and an embodiment of the present invention satisfies these needs, thereby improving the prior art.

In a scenario close to those set forth above, if a person signs-on to the Internet, her presence is even more noticeable than if she had logged into a network along some proprietary line. If she completes a task by manipulating data from her office, even if encrypted, she still will leave a trace signature or footprint that is discoverable, but just harder to decipher. The subject invention enclosed herein also addresses the issue to erase these trace signatures. This includes, but is not limited to erasing internet cache files, cookies, temporary files such as those created by Microsoft Word®, registry entries, files, environmental variables, favorites, passwords, etc. Furthermore, for certain security levels, simple erasure is not adequate. For example, simply erasing a file does not eliminate the data from the guest hard drive, being that it can be “undeleted” or, even if it could not be undeleted, a malicious user could create a large new file and seek through it looking for useful information. Various file erasing algorithms are available for completely erasing a file which may include overwriting the file before deleting it, perhaps in several passes.

In a corporate environment, there is an overwhelming desire to increase productivity and that is constantly being balanced with a need to protect certain information from being retrieved and quickly exported (stolen) by someone without authority. Information, such as trade secrets and human resources department documents must be protected. To do so, security levels are set and authentication protocols are established for those that are permitted to wander freely about the network, and have access to restricted documents. However, no integrated system of the prior art allows a person, having a high level of authenticity, to easily move around the entire network while maintaining a simultaneous high level of expected privacy. That is because most prior art systems trade security for privacy. Accordingly, multiple systems have to be deployed to permit both extensive privacy and high level authentication. And in many instances, these systems are not compatible, which leads to conflicts. An improved integrated system is clearly needed to solve the problems of the prior art currently utilized within corporations. These multiple, but traditionally incompatible technologies need to be incorporated into one integrated system and provide all aspects of privacy and authentication under one roof to this highest possible level. The method of the present invention provides such capabilities.

Still within the confines of a corporate structure, consider a traveling executive who is on business at another company office across the country, wherein the security and privacy protocols established are different than those of his office. Potential protocol conflicts can lead to problems for this traveling executive even though he holds a very high level of clearance for both privacy and security with the company. He can be effectively locked out, because he is typically not located in this office. An integrated system like that described directly above needs to be implemented having a traveling authentication element for calculating a highly probable truthful analysis, so that certain candidates can be quickly authenticated and permitted to move freely through a home or traveling office and its confidential files with privacy attached.

Regardless of the size of a business, such as a large multi-national corporation, a medium sized business or a small sized business, or even just an average home personal computer owner, the issue of restoration (of a computer) will eventually play a part in the life of the computer user, owner or administrator. The ability to quickly restore a computer, to its previously undamaged state, will be an issue at some point in time. Being able to restore quickly will be necessary. However, what may be more important is the accuracy of all restored information and the time/date that the restored information was last backed-up. In most small to medium businesses, some sort of hard disc or tape drive system is employed as a backup. In larger companies, they may use entire banks of storage devices that are referred to as centralized storage devices (CSD). In any sized corporation, large or small, or even on the personal level, there may be a virus or worm attack that brings down a part or the entire system or network. No one is immune. It has been said that international worm and virus attacks account for more than $20 Billion a year in actual and productivity losses for industry.

In the example of large corporations, entire sections of networks could need restoration. The problem is exacerbated when the network server itself is not backed-up, by not being attached to a redundant backup system. If this happens, a large portion of the workforce of the company could be rendered unproductive during the restoration process thereby lowering the overall productivity and effectiveness for at least a period of time. Other events that can cause a need for restoration, and include, but are not limited to, the loading of rogue applications on workstations, which slows down workstation productivity thereby contributing to a reduction in productivity and resulting in a complete reloading of the operating system. In this event, all user profiles are lost simply because they were never saved anywhere else except the workstation local storage medium. Hard drive failure can also cause complete and catastrophic failure and loss of all user profiles if not backed-up in some manner. The inventive system of this patent application has a solution for both personal computer users and corporate networks, large and small, to reduce or eliminate, in their entirety, all of these problems of the prior art.

### SUMMARY OF THE INVENTION

For the purposes of this application, and as seen in FIGS. 1-3, Guest profile begins at guest computer, which is a place of origin (a starting point) and is interchangeable with Home Computer. Further, visitor as shown in FIG. 3, is a location of friend's computer whose Guest profile has an option to visit either from guest computer (home) or host computer. Host computer is a computing device which is willing to accept Guest profile and allow Guest profile to operate in dominance over any Host profile, yet provide Guest with all resources and peripherals that are available.

Further words that appear in the following text, some of which are also shown in the Figures, warrant a proper understanding of their meaning and therefore a definition. Accordingly, for the purposes of this application, SYNC means to make files common or alike. RESYNC means to make uncommon files alike. PRIVATE means the ability to leave a computing device host without leaving any discoverable traces of guest profile behind.

The present invention utilizes a method of real time synchronization to constantly sync an entire user-defined profile from a computing device to an external storage device while encrypting the profile contents on-the-fly. The user-defined profile is established by the operator of the computing device. The profile represents the essence of the computing device as defined by the user—its persona. These elements include but are not limited to data files (mp3, MPEG, word processor files, jpg, etc.), applications, operating system, and all of the user-defined preferences and settings available to the device user. These user-defined preferences and settings include, but are not limited to, desktop environment, bookmarks on browser, cookies, specific application settings, e-mail files, non-licensed programs and applications, folder structure of files, and the address book. The profile can be as big or as little as the user desires. It is important to note that the definition of profile, used herein, does not attempt to exclude other electronic computing devices that are not defined within the category. For instance, ATMs have profiles and can be synchronized utilizing the novel method of the present invention.

In its simplest form, our invention allows for real time synchronization of a computing device user-definable profile to an external storage device while, perhaps, encrypting the information on-the-fly. Nothing herein limits that external storage device be portable or actually be a transport device, or be a separate disk partition, or be a networked attached storage device, for the user-defined profile. However, it is external in the sense that is not enclosed within the housing of the computing device and therefore accessible from outside any housing. However, one embodiment, utilizes a high-speed, large capacity device located within a small housing that can easily fit into a shirt pocket, briefcase, or purse and plug directly into a reciprocal port of a computer, such as USB or IEEE 1394 (Firewire) for immediate synchronization.

Our method also allows switching between two computers regardless of platform, operating system, framework, network architecture and/or application compatibility. Further, location of the second computer is irrelevant. Accordingly, it does not matter if the user is traveling abroad or just switching between computers at home and work. Our method accesses a user's profile under username/password as defined by an authentication measurement based upon a high probability for truthfulness. This is achieved in the office, home or while traveling. Our method has the option to synchronize through an intermediary drive (e.g. USB flash memory as a drive or any other external storage device), or directly from computer to computer. If an intermediary drive is to be used, it can be can portable.

As an example of our method, a profile of a first computer can SYNC to an external transport device and then RESYNC to a second computer anytime thereafter. After RESYNC at the second computer, the second computer, along with the external transport device, will hold the profile for as long as the user decides, until released by terminating SYNC to the intermediary drive. The intermediary drive can then carry the modified profile where ever it needs to go. A typical place may be back home (the place of origin), or guest computer, for RESYNC to guest computer where the journey first began. This makes it possible to work on a second computer without the need to connect through the Internet or other network system of connectivity. In this way, files and functions of both computers (the profile) are always available at both locations so long as synchronization has occurred.

Our method can be used for upgrading computers when updating just the software and not changing any hardware, when updating just the hardware and not any software or when updating both the hardware and the software. The transport method utilizes and captures the user profile in a series of pre-defined and user-defined areas and then executes synchronization and resynchronization protocols between the computers by the SYNC and RESYNC functions. Our method ensures that all user files defined as part of the profile are preserved and remain private to the user, perhaps, by use of encryption, thereby permitting the user to have access to the user-defined profile on an upgrade within seconds of completion of the upgrade. Our method is not dependent upon upgrading to the same or like operating system but can be used to interface to any software vendor. Operating system incompatibility is not at issue.

Our method allows a user access to her profile on a computer not belonging to her while maintaining the same level of privacy as if she were on her own computer, utilizing her own authentication and leaving footprints of such a minimal amount that her identity and the fact that she was there is, for all practical purposes, impossible to discover when after departing. In addition, she can also complete tasks (i.e., edit documents and other files) and still leave under the same level of secrecy if she has gone PRIVATE during synchronization.

In maintaining a person's status as private on a non-personal computer, especially in a corporate Intranet, our method provides for a person having a high level of authenticity to easily move around an entire network and enjoy access to everything that his security level permits. At the same time he maintains and enjoys a level of privacy equal to that he is use to and that which his probability for truthfulness has previously assigned to him. Our integrated system can be used within corporations that have multiple incompatible technologies. These incompatible technologies are incorporated into all aspects of our integrated system and within the corporate identification, verification and authentication system and privacy function. Our integrated system includes a unique computer profile formation system having a SYNC/RESYNC capability for permitting a created profile, representing an individual having a computer “personality”, based upon characteristics previously and presently entered, to wander about a network and have that profile brought forward to be seen at anytime at any workstation, all the while having a high probability form truthfulness identity working in conjunction with the system to use for network system security. In anticipation of a traveling executive, the same criteria can exist with just a few more qualifying questions.

Remote user profile restoration is used when a user suffers a major virus attack in a company. For instance, the system administration staff may have to completely reinstall the operating system and all applications. They recover the last backed-up data. There is no restoration of the user's profile and no restoration of any private applications a user may have installed on the computer and therefore no restoration of the computer persona (profile). We allow individuals as well as systems administration staff to have control over there restorations, including their computer persona, based upon status at company.

### BRIEF DESCRIPTION OF THE DRAWINGS

The invention can be best understood by those having ordinary skill in the art by reference to the following detailed description when considered in conjunction with the accompanying drawings, wherein:

FIG. 1 illustrates a process flow diagram of how a Guest synchronizes (SYNC/RESYNC) his profile through a portable storage device from a guest computer to a host computer;

FIG. 2 illustrates a process flow diagram of how a Guest can synchronize (SYNC/RESYNC) his profile with a host computer or temporarily synchronize (SYNC/PRIVATE-RESYNC) with a visitor Computer; wherein if Guest profile first synchronizes (SYNC/RESYNC) with the host computer, then Guest profile can synchronize (SYNC/RESYNC) with the guest computer or temporarily synchronize (SYNC/PRIVATE-RESYNC) with the visitor Computer; however, if Guest profile instead first synchronizes (SYNC/PRIVATE-RESYNC) with the visitor Computer, then Guest profile can synchronize (SYNC/RESYNC) with the host computer or synchronize (SYNC/RESYNC) back home to the guest computer;

FIG. 3 is a flow diagram representing a “round-trip” day at work wherein the Guest first starts the day at home and synchronizes to an external portable storage device to transport (drive) from the guest computer (home) to the host computer (office); he then resynchronizes at the office to host computer permitting Guest profile to work in real time sync with host computer; thereafter modified Guest profile, having a real time synced profile, synchronizes to the external portable storage device to transport back home and resynchronize to guest computer thereby establishing the modified Guest profile, having been worked on, in real time sync, at the host computer, on the guest computer;

FIG. 4 is a diagram illustrating a plurality of workstations WS1 thru WSn on a network all coupled to a centralized storage device (CSD) permitting back-up of all user-defined profiles through synchronization to the CSD; and

FIG. 5 is a diagram illustrating a plurality of workstations WS1 thru WSn on a network all coupled to a centralized storage device (CSD) for permitting resynchronization of all, user-defined profiles if needed.

FIG. 6 is a schematic diagram of an exemplary computer system of the present invention.

### DETAILED DESCRIPTION OF THE INVENTION

Throughout the following detailed description, the same reference numerals refer to the same elements in all figures.

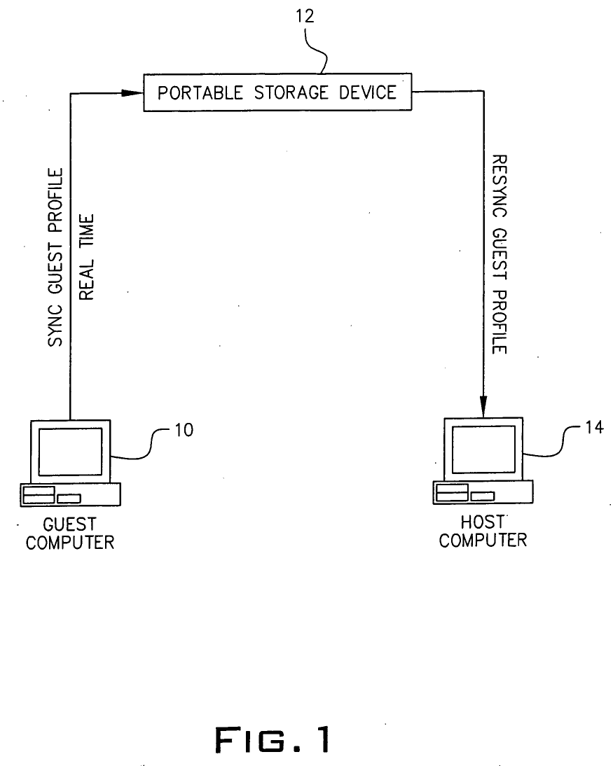

Referring to FIG. 1, it is shown that guest computer 10 can be connected to a portable transport device 12 for copying files defined in guest computer 10 as being part of the profile and therefore part of SYNC procedure, previously defined in the summary above. SYNC is accomplished in real time so that any changes made to profile during SYNC, will instantly be copied to transport device 12, perhaps encrypting the profile on-the-fly. In the preferred embodiment, portable transport device 12 is an external Flash or hard drive having a large storage capacity, such as 2.0 Gigabytes or 100 Gigabytes. In alternate embodiments, transport device 12 is an intermediary device such as an external hard drive. Transport device 12 can plug directly into the USB port or IEEE 1394 (FireWire port) (not shown) of guest computer 10 for synchronization between guest computer 10 and transport device 12. However, nothing herein limits transport device 12 to being portable. In fact, transport device 12 could be a large stationary device having an extremely large storage capacity. Furthermore, nothing limits the device to being “plugged in” to the guest computer, in that the device may connect to the guest computer through an already existing connection, for example, a network connection.

With continuing reference to FIG. 1, transport device 12 resynchronizes with a host computer 14 through a similar interfacing by a RESYNC procedure, perhaps, decrypting on-the-fly. After RESYNC has occurred, the profile on host computer is identical to that of guest computer 10. Although FIG. 1 shows both guest and host computers, 10 and 14 respectively, connected to transport device 12, it is understood that a typical procedure would have these two events happen successively with some measurable amount of time occurring between synchronization.

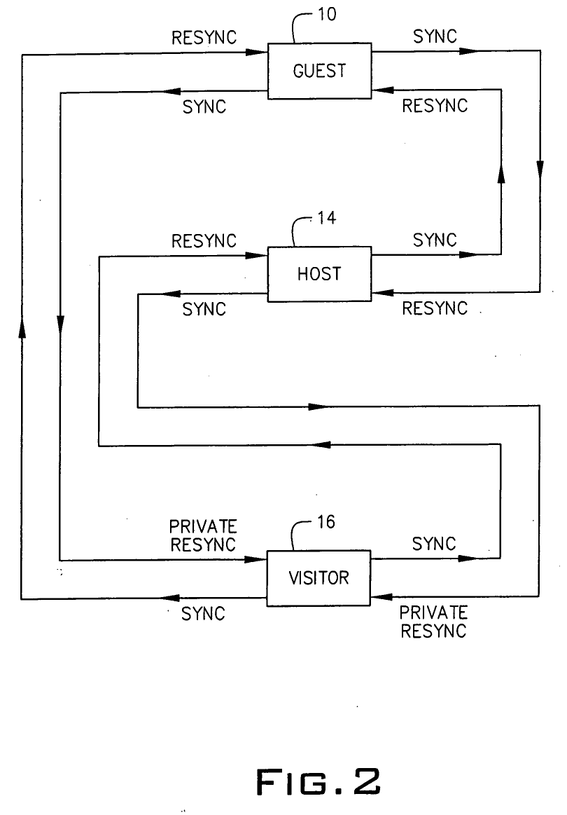

As shown in FIG. 2, various options are available to guest computer for her to move the profile from guest computer 10 to host computer 14 or to visitor Computer 16. The only difference is that if her profile from guest computer 10 resynchronizes with visitor Computer 16 directly or after going through host computer 14, she will have the option to enter with a temporary profile, or PRIVATE-RESYNC, which erase all traces of her presence that her profile was ever there. This may, for example, include deleting files, keys, passwords, temporary files, internet caches, cookies, etc. In one embodiment, the method of deleting may simple deletion. In yet another embodiment, the method of deleting may include a more secure method of deleting files that may include overwriting the files with random data, possibly several times, before deleting. The same is also true for host computer 12. Regardless of where she was, before entering visitor Computer 16 she always has the option to enter a PRIVATE-RESYNC.

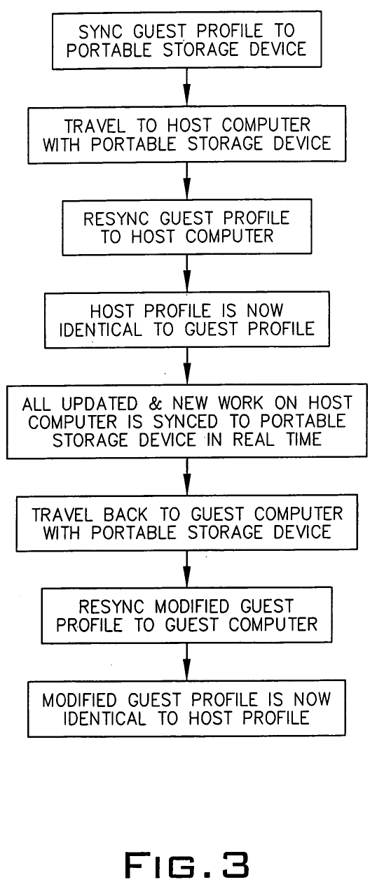

Referring to FIG. 3, a flow diagram representative of a “round-trip” day at work is shown wherein a guest profile is at home and the host computer 14 is at an office and an external portable storage device 12 is being employed. SYNC of Guest profile from guest computer to portable storage device occurs first, at home. The user then travels to their office, carrying the portable storage device. When arriving at the office, the profile goes RESYC and works in real time sync with guest profile all day at host computer. When done at the office, the user disconnects the portable storage device and travels back home. After the portable storage device is connected to the guest system at home, the guest computer 10 goes SYNC to transport device 12 and guest computer 10 receives modified profile by RESYC.

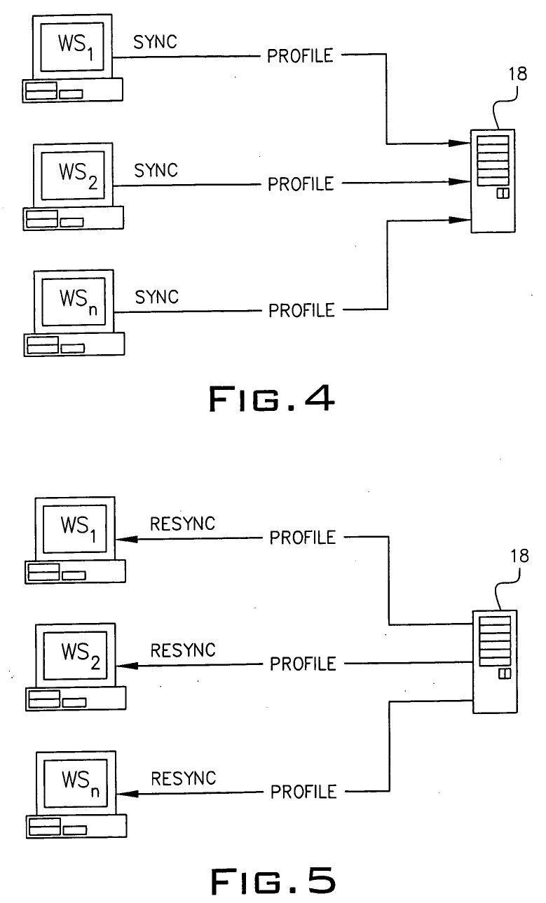

Referring to FIG. 4, a diagram is shown illustrating a plurality of workstations WS1, WS2 AND WSn, wherein “n” represents some unknown number of workstations from three to infinity. Workstations WS1 through WSn are all coupled to a central storage device (CSD) 18 and constantly SYNC their user-defined profiles to CSD 18. The frequency of the SYNC can be set by each user of WS1 though WSn.

Referring to FIG. 5, a diagram is shown illustrating a plurality of workstations WS1, WS2 and WSn, where in “n” represents some unknown number of workstations from 3 to infinity. Workstations WS1 through WSn are all coupled to central storage device (CSD) 18 and can RESYC their user-defined profiles from CSD 18 to each workstation respectively.

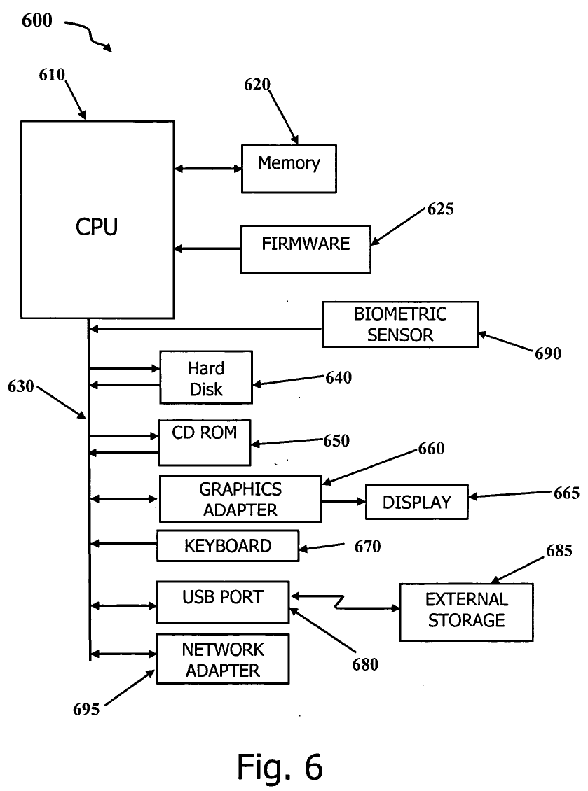

Referring to FIG. 6, a schematic block diagram of a computer-based system 600 of the present invention is shown. In this, a processor 610 is provided to execute stored programs that are generally stored within a memory 620. The processor 610 can be any processor, perhaps an Intel Pentium-4 ® CPU or the like. The memory 620 is connected to the processor and can be any memory suitable for connection with the selected processor 610, such as SRAM, DRAM, SDRAM, RDRAM, DDR, DDR-2, etc. The firmware 625 is possibly a read-only memory that is connected to the processor 610 and may contain initialization software, sometimes known as BIOS. This initialization software usually operates when power is applied to the system or when the system is reset. Sometimes, the software is read and executed directly from the firmware 625. Alternately, the initialization software may be copied into the memory 620 and executed from the memory 620 to improve performance.

Also connected to the processor 610 is a system bus 630 for connecting to peripheral subsystems such as a hard disk 640, a CDROM 650, a graphics adapter 660, a biometric sensor 690, a Universal Serial Bus (USB) port 680, a keyboard 670 a biometric sensor 690 and a network adapter 695. The graphics adapter 660 receives commands and display information from the system bus 630 and generates a display image that is displayed on the display 665.

In general, the hard disk 640 may be used to store programs, executable code and data persistently, while the CDROM 650 may be used to load said programs, executable code and data from removable media onto the hard disk 640. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. Other devices may be connected to the system through the system bus 630 or with other input-output functions. Examples of these devices include printers; mice; graphics tablets; joysticks; and communications adapters such as modems and Ethernet adapters.

In some embodiments, the USB port 680 may be connected to an external storage device 685. The example shown has an external storage device 685 which may be a flash drive, memory card or external hard drive. In another embodiment, the external storage may be connected to the system with an interface other than USB, perhaps IEEE 1394 (Firewire). In another embodiment, the external storage is located on a remote system connected by networking to that system, perhaps connected to a server, a Network Attached Storage device (NAS) or connected to the world-wide-web.

In some embodiments, the biometric sensor 690 may be used to encrypt profile information while in transit. Examples of a biometric sensor 690 include fingerprint scanners, voice recognition, facial recognition, retina scanners and iris scanners.

Equivalent elements can be substituted for the ones set forth above such that they perform in the same manner in the same way for achieving the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A system for transporting profiles comprising:
a first computer system;
a second computer system;
a storage external to both said first computer system and said second computer system;
a first software module configured to capture a user profile in real time from said first computer system and configured to synchronize said user profile to said storage.

2. The system of claim 1, wherein a second software module configured to resynchronize said user profile from said storage onto said second computer.

3. The system of claim 1, wherein said storage system is selected from a group consisting of a flash device, an external disk drive, a memory card, storage within a local network, storage with the world-wide-web and a network attached storage.

4. The system of claim 1, wherein said profile comprises a set of files, a set of user-defined preferences and a desktop environment.

5. The system of claim 2, wherein said first software module encrypts said user profile and said second software module decrypts said user profile.

6. The system of claim 5, wherein said first software module and said second software module use biometric data to encrypt and decrypt.

7. The system of claim 6, wherein said biometric data is selected from a group consisting of a fingerprint scan, an iris scan, a retina scan, a voice recognition and a facial recognition.

8. A method for migrating a user profile comprising:
extracting a user profile from a first computer system;
saving said user profile on a storage that is external to said first computer system;
recreating said user profile on a second computer system from said storage.

9. The method of claim 8, further comprising a step of encrypting said user profile after said step of extracting.

10. The method of claim 8, further comprising a step of decrypting said user profile after said step of saving.

11. The method of claim 8, further comprising a step of erasing said user profile from said first computer system after said step of extracting.

12. The method of claim 11, wherein said erasing includes overwriting files within said profile with random data before deleting said files.

13. The method of claim 8, wherein said storage is selected from a group consisting of a flash device, an external disk drive, a memory card, storage within a local network, storage with the world-wide-web and a network attached storage.

14. The method of claim 9, wherein said step of encrypting uses biometric data as an encryption key.

15. The method of claim 14, wherein said biometric data is selected from a group consisting of a fingerprint scan, an iris scan, a retina scan, a voice recognition, DNA recognition and a facial recognition.

16. A method for migrating a profile comprising:
extracting a user profile from a first computer system;
saving said user profile on a storage that is external to said first computer system;
recreating said user profile on a second computer system from said storage;
using said user profile on said second computer system;
when finished using said second computer system, re-extracting said user profile from said second computer system;
re-saving said user profile on said storage; and
restoring said user profile from said storage that is external to said first computer system onto said first computer system.

17. The method of claim 16, wherein said storage is selected from a group consisting of a flash device, an external disk drive, a memory card, storage within a local network, storage with the world-wide-web and a network attached storage.

18. The method of claim 16, further comprising a step of erasing said user profile from said first computer system after said step of re-extracting.

19. The method of claim 18, wherein said erasing includes overwriting files within said profile with random data before deleting said files.

20. The method of claim 16, further comprising a step of encrypting said user profile after said step of extracting and a step of decrypting said user profile after said step of saving.

21. The method of claim 20, wherein said encrypting and said decrypting use biometric data to encrypt and decrypt.

22. The method of claim 21, wherein said biometric data is selected from a group consisting of a fingerprint scan, an iris scan, a retina scan, a voice recognition, DNA recognition and a facial recognition.
